(19) United States
(12) Patent Application Publication
(10) Pub. No.: US 2020/0288664 A1
(43) Pub. Date: Sep. 17, 2020

(54) Litter Box Container

(71) Applicant: Laurie Ott, Anchorage, AK (US)

(72) Inventor: Laurie Ott, Anchorage, AK (US)

(21) Appl. No.: 16/818,336

(22) Filed: Mar. 13, 2020

Related U.S. Application Data
(60) Provisional application No. 62/817,774, filed on Mar. 13, 2019.

(51) Int. Cl. A01K 1/01

(52) U.S. Cl. CPC A01K 1/0107

(57) ABSTRACT

A litter box container. The litter box container includes a planar surface. The planar surface may rest on a substantially flat surface. A plurality of walls is formed around the perimeter of the planar surface and extend upward. The plurality of walls forms an interior volume. The interior volume is accessible via an open upper end. Furthermore, the plurality of walls is made of a flexible material that is bendable when force is applied to them.

### CROSS REFERENCE TO RELATED APPLICATIONS

This application claims the benefit of U.S. Provisional Application No. 62/817,774 filed on Mar. 13, 2019. The above identified patent application is herein incorporated by reference in its entirety to provide continuity of disclosure.

### BACKGROUND OF THE INVENTION

The present invention relates to an apparatus that is to be used in conjunction with a litter box, or similar structure, to allow for a user to more easily clean the area surrounding such a structure and to prevent the unwanted distribution of the contents of the structure in an expanded area around the structure.

Many individuals across several geographies and demographics raise pets for functional purposes, such as pest control or for assistance with disabilities, while other individuals may raise pets primarily for companionship. Domestic cats are among the most commonly furnished pets in urban, suburban and rural locations. Regardless of location, most domestic cats spend the majority of their lives within indoor structures and residences. In order to accommodate this lifestyle, most cat owners utilize litter boxes to provide an apparatus for the cat to relieve itself within. Some other pets, such as rabbits, ferrets, miniature pigs and small dogs may also utilize litter boxes.

Litter boxes vary significantly in structure and construction. However, most litter boxes share several common characteristics. For example, every litter box provides an access mechanism into a container, where the container is filled with an absorbent material. The access mechanism may comprise an entirely open top surface, or may be a cavity disposed through a full housing. The cavity may additionally contain some form of cover or flap to keep the absorbent material within the full housing. The absorbent material disposed within the litter box may consist of a conventional litter, such as clay. Other types of absorbent material that provide additional benefits may be utilized as well, such as “clumping” litter materials that include a dessicant, such as silica gel, calcium bentonite, quartz mineral or diatomaceous earth. Other litter boxes provide even further benefits and constructions, such as self-cleaning functions, top-entry access mechanisms, hoods, or are made of disposable materials.

Regardless of the configuration and construction of the litter box, there have been consistent problems for cat owners in the form of messes created by litter boxes. When cats, or other animals, use litter boxes, the absorbent materials may become attached to the paws or the fur of the animal while it is using the litter box. Upon exiting the litter box, this material, as well as fecal or urinary products, can become displaced upon the surfaces surrounding the litter box. Additionally, the absorbent materials and other contents of the litter box may be “flung” or otherwise displaced when the animal is entering the litter box. Some animals, by instinct, may kick their legs to dig or bury their product within the litter box.

There are several concerns that can arise from absorbent material and other litter box contents becoming displaced from the litter box. If the litter box materials are displaced upon a carpeted surface, the pet owner will need to spend a significant amount of time cleaning the carpeted area to remove the granules of absorbent material that may become embedded in the carpeted area. Furthermore, the litter box materials may cause the carpeted area to take on a litter box smell that can be unpleasant and difficult for the pet owner to cover up or remove. Additionally, if the litter box contents become displaced upon hard-wood or tiled surfaces, the granules of absorbent material may become wedged or stuck between the gaps of the tiles or slats. Additionally, the granules, if of a sufficient hardness, may scrape or otherwise damage a varnish or finishing coating which has been applied to the hardwood or tiled surface.

Some litter pads are on the market currently, however, these products fail to provide sufficient structural capacity to fully remove litter box materials from the animals as they depart from the litter box. For example, some of these inventions consist of a platform that the pet must walk across to exit from the litter box. Other inventions comprises a plurality of apertures on a surface that are configured to receive litter box materials therethrough as the pet passes over the surface. Other methods include intricate structures designed to partially or fully encompass the litter box apparatus, however, most of these devices are difficult to install and are not convenient for users who wish to maintain a discrete presence of their litter box.

Therefore, there is a defined need amongst the known prior art references for an apparatus that is easy to use, easy to clean, discrete and effective and solves the problem of litter box materials becoming significantly displaced upon the area surrounding the litter box.

### SUMMARY OF THE INVENTION

In view of the foregoing disadvantages inherent in the known types of litter box pads and apparatuses now present in the prior art, the present invention provides a litter box container wherein the same can be utilized for providing convenience for the user when preventing the displacement of litter box materials upon an area surrounding a litter box.

The present system comprises a planar surface. The planar surface is flat and configured to rest on a horizontal or substantially horizontal surface. A plurality of walls extend upward from the planar surface. The plurality of walls defines an interior volume. The interior volume is configured to have a litter box for a cat or other small pet to be placed inside. The plurality of walls is made of a flexible material, such that they can bend as the pet walks over them. As such, any dirt, debris or litter box material will be contained therein as the pet leaves the litter box.

In some embodiments, the present system further comprises a planar surface and a plurality of walls that are made of a translucent material or a transparent material. As such, the user may view the surface underlying the planar base through the litter box container.

In other embodiments, the present system further comprises a plurality of fasteners disposed on the plurality of walls extending upward from the planar surface. As such, the litter box container can be moved between an assembled position and a disassembled position.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the litter box container in an assembled position.

FIG. 2 shows a perspective view of an embodiment of the litter box container in a disassembled position.

FIG. 3 shows a perspective view of an embodiment of the litter box container in use.

### DETAILED DESCRIPTION OF THE INVENTION

Reference is made herein to the attached drawings. Like reference numerals are used throughout the drawings to depict like or similar elements of the litter box container. The figures are intended for representative purposes only and should not be considered to be limiting in any respect.

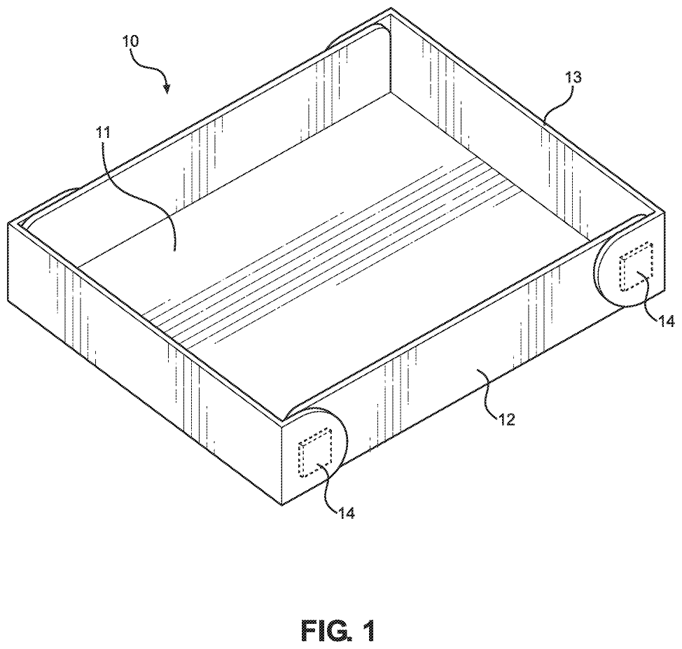

Referring now to FIG. 1, there is shown a perspective view of an embodiment of the litter box container in an assembled position. The litter box container 10 comprises a planar surface 11. The planar surface 11 is flat and is configured to rest on a horizontal or substantially horizontal surface, such as a floor or ground surface.

A plurality of walls 12 extend upward from the planar surface 11. The plurality of walls 12 define an interior volume with an open upper end 13. The open upper end 13 enables access to the interior volume. Furthermore, the plurality of walls 12 is made of a flexible material. As such, the plurality of walls 12 will bend should they come into contact with a pet as they are departing from the litter box container 10. In the specific demonstration, the plurality of walls 12 consists of a first wall, a second wall, a third wall and a fourth wall arranged in a rectangular configuration.

The planar surface 11 and the plurality of walls 12 are made of any suitable material. In some embodiments, the planar surface 11 and the plurality of walls 12 are made of a transparent material or a translucent material, such that the planar surface 11 and the plurality of walls 12 may be discrete and may substantially blend in with the floor. Alternatively, the planar surface 11 and the plurality of walls 12 may be made of a similar material as the floor upon which it is sat, thus further increasing the discretion of the litter box container 10.

In the illustrated embodiment, the litter box container 10 comprises a plurality of fasteners 14. The plurality of fasteners 14 are disposed on the plurality of walls 12 and are adapted to maintain the plurality of walls 12 in an assembled position as demonstrated. The plurality of fasteners 14 consist of any suitable fastener capable of securing a first wall of the plurality of walls 12 to a second wall of the plurality of walls 12. For example, in some embodiments, the plurality of fasteners 14 consist of a plurality of hook and loop fasteners. However, in alternate embodiments, the plurality of fasteners 14 may consist of a plurality of adhesives, a plurality of straps or a plurality of magnets. In some embodiments, the plurality of fasteners 14 is made of a transparent material or a translucent material. As such, the litter box container 10 can be further blended in with the surrounding environment.

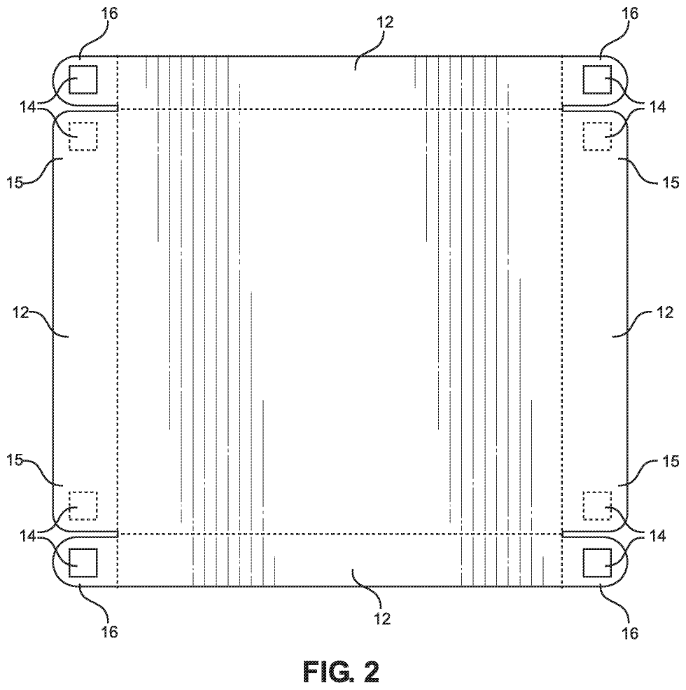

Referring now to FIG. 2, there is shown a perspective view of an embodiment of the litter box container in a disassembled position. In the shown embodiment, the litter box container 10 is in the disassembled position. In some embodiments, the plurality of walls 12 are defined by a plurality of connection tabs. The plurality of connection tabs consist of a first member 15 that is brought into orthogonal alignment with a second member 16, when placed into the assembled position. The plurality of fasteners 14 are engaged when the first member 15 and the second member 16 are brought into contact with each other.

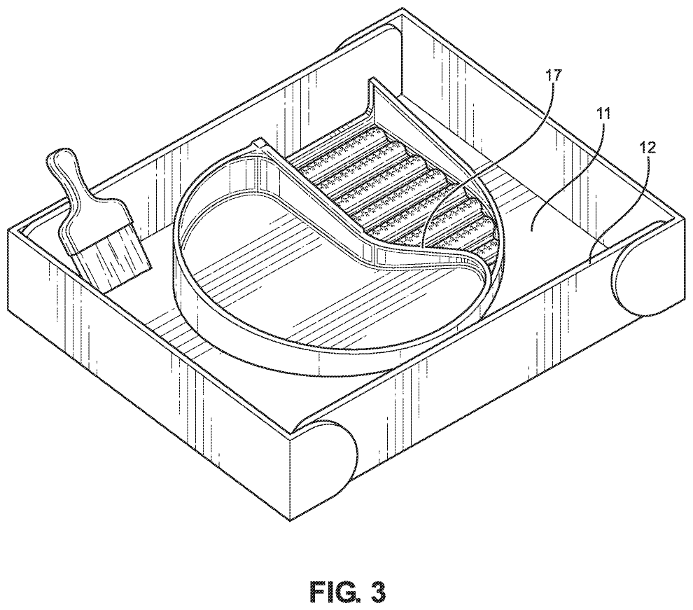

Referring now to FIG. 3, there is shown a perspective view of an embodiment of the litter box container in use. The planar face 11 of the litter box container 10 is dimensioned to receive a litter box 17 therein. Specifically, in the illustrated embodiment, the planar surface 11 is of a rectangular shape and has a greater length, width, perimeter and area than the litter box 17 that is placed therein. Specifically, the base of the litter box 17 is of a lesser area than the planar surface 11. In alternate embodiments, the planar surface 11 may be of an alternate shape, however, it is not required that the planar surface 11 and the litter box 17 be of the same shape. Furthermore in the illustrated embodiment, the plurality of walls 12 extend upward from the planar surface 11 a greater distance than the litter box 17, such that the litter box 17 is entirely contained within the interior cavity.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A litter box container, comprising:
a planar surface;
a plurality of walls extending upward therefrom;
the plurality of walls defining an interior volume that is accessible via an open upper end;
the plurality of walls being made of a flexible material.

2) The litter box container of claim 1, wherein the planar surface and the plurality of walls are made of a translucent material.

3) The litter box container of claim 1, wherein the planar surface and the plurality of walls are made of a transparent material.

4) The litter box container of claim 1, wherein a plurality of fasteners is disposed on the plurality of walls and are configured to maintain the plurality of walls in an assembled position.

5) The litter box container of claim 4, wherein the plurality of fasteners is transparent;

[symbol]

6) The litter box container of claim 4, wherein the plurality of fasteners is a plurality of hook and loop fasteners.

7) The litter box container of claim 1, wherein the planar surface is dimensioned to receive a litter box therein.

8) The litter box container of claim 7, wherein the plurality of walls extends upward above a top edge of the litter box.

9) The litter box container of claim 7, wherein the planar surface is of a greater area than a base of the litter box.

10) The litter box container of claim 1, wherein the plurality of walls defines a plurality of connection tabs at a plurality of intersections thereof, wherein each connection tabs consists of a first member in orthogonal alignment with a second member.

11) The litter box container of claim 1, wherein the planar surface is rectangular in shape.

12) The litter box container of claim 1, wherein the plurality of walls consists of a first wall, a second wall, a third wall and a fourth wall.

13) A litter box container, comprising:
a planar surface;
the planar surface dimensioned to receive a litter box thereon;
a plurality of walls extending upward therefrom;
the plurality of walls defining an interior volume that is accessible via an open upper end;
the plurality of walls extending upward above a top edge of the litter box;
the plurality of walls being made of a flexible material;
wherein the planar surface and the plurality of walls are made of a transparent material;
a plurality of fasteners disposed on the plurality of walls and are configured to maintain the plurality of walls in an assembled position.

14) A litter box container, comprising:
a planar surface;
the planar surface being rectangular in shape;
the planar surface dimensioned to receive a litter box thereon;
a plurality of walls extending upward therefrom;
the plurality of walls consisting of a first wall, a second wall, a third wall and a fourth wall;
the plurality of walls defining an interior volume that is accessible via an open upper end;
wherein the plurality of walls defines a plurality of rigid buttresses at a plurality of intersections thereof, wherein each rigid buttress consists of a first member in orthogonal alignment with a second member;
the plurality of walls extending upward above a top edge of the litter box;
the plurality of walls being made of a flexible material;
wherein the planar surface and the plurality of walls are made of a transparent material;
a plurality of fasteners disposed on the plurality of walls and are configured to maintain the plurality of walls in an assembled position;
wherein the plurality of fasteners is transparent.
